(19) United States
(12) Patent Application Publication
(10) Pub. No.: US 2013/0025614 A1
(43) Pub. Date: Jan. 31, 2013

(54) BEAUTY AND HEALTH CONTAINER WITH FLOSS DISPENSER

(71) Applicant: Julie Corinne Morgan, Brentwood, CA (US)

(72) Inventor: Julie Corinne Morgan, Brentwood, CA (US)

(21) Appl. No.: 13/191,343

(22) Filed: Jul. 26, 2011

(51) Int. Cl. A45D 40/18; A61C 15/04; A45D 34/06

(52) U.S. Cl. 132/200; 132/314; 132/324

(57) ABSTRACT

A cosmetic container/applicator having a compartment for holding a dental floss dispenser refill, where the compartment is located at either end of an elongated cosmetic container/applicator. The compartment can be left empty without the dental floss dispenser to hold a pill. This compartment may be an integral piece with the container body, or with the cap of the container. This compartment may also be a separately available after-market attachment such that a user may attach it to a cosmetic container by known means. The container may optionally have a LED light in its cap to provide lighting when a user applies the cosmetic content. The body of the container may also have a mirror disposed on its side wall.

### CROSS-REFERENCE TO RELATED APPLICATIONS

Not Applicable.

### BACKGROUND OF THE INVENTION

(1) Field of the Invention

The field of the invention is personal care and cosmetic product containers, more specifically, cosmetic applicator having a dental floss dispenser, a light, and a mirror.

(2) Description of Related Art including Information Disclosed under 37 CFR 1.97 and 1.98

Cosmetics containers are well known in the art. A large variety of such containers are currently commercialized and sold. There are typically various different types of small-size cylindrical containers for containing lipstick, mascara, eyeliner, lip liner, lip gloss, nail polish, and other health and beauty aids. Such elongated, tubular containers, with the cosmetics included therein, are widely used by people from adolescence to old age.

Such containers typically function only as a container of the cosmetic product contained within or may also include an applicator.

It is an object of the present invention to provide a novel series of new containers having multiple functions for health and beauty aids, such that the container not only functions as a cosmetic container, but also provides other functions such as a mirror, a dental floss dispenser, and a pill box.

It is yet another object of the present invention to provide a method to minimize untidy clutter in one's purse by combining the functions of various items onto one cosmetic container.

It is yet another object of the present invention to provide an after-market attachment piece to attach to a cosmetic container, so that any original cosmetic container can now perform multiple functions.

It is a further object of the present invention to provide a dental floss refill for use in conjunction with a multi-purpose cosmetic container.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies, and the definition of that term in the reference does not apply. Further, the invention may seek to satisfy one or more of the above-mentioned desires. Although the present invention may obviate one or more of the above-mentioned desires, it should be understood that some aspects of the invention might not necessarily obviate them.

### BRIEF SUMMARY OF THE INVENTION

Among the many different possibilities contemplated, the contemplated personal-care system can be a typical cosmetic applicator/container (such as those commonly known for lip gloss, lipstick, mascara, liquid foundation, foundation pressed powder, concealer, blush, eye shadow, skin lotion, sunblock lotion, lip liner, nail polish and eye liner) with added multiple functions by incorporating a separate compartment to hold a dental floss dispenser. Optionally, the system may have a light source, such as LED light, for example in the cap of the container.

As for the container, it has a main body with a distal end, a proximal end, and a hollow interior space to hold a cosmetic content. It also has a lid (or cap) coupled to the proximal end of the main body. It may be a typical screw-on cap.

This novel container has a compartment located at the end of either the distal end of the main body or on an end of the lid. The idea is to have a compartment at either end of an elongated cosmetic container. Some embodiments may even have compartments at both ends of the elongated cosmetic container.

This compartment portion may be manufactured as an integral part of the main container body, or an integral part of the lid, or both.

Alternatively, this compartment portion can be a separate piece that is separately made, and can be later attached (permanently or detachably) to such cosmetic container/applicator by a user. In one embodiment of the contemplated method, this separate piece can be sold separately as a refill.

The compartment can contain a dental floss dispenser, or it can be optionally left empty to hold other personal items such as pills. If a dental floss dispenser is be to placed inside this compartment, the dental floss dispenser can be a refill, sold separately.

In another contemplated embodiment, the cosmetic container can have a mirror disposed on its side or sides.

The contemplated invention also includes a method of adding functionality to a cosmetic container. It is also a novel product-marketing method by creating value to commonly-known cosmetic containers/applicators. The novel method includes producing a new container having an extra compartment as described herein. The method also includes introducing an after-market accessory attachment to be attached to commonly-known cosmetic containers/applicators by a consumer.

Further contemplated is a method to enhance a display of cosmetic products by providing internal light sources so the container, and its content can be lit from the inside.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

It should be noted that the drawing figures may be in simplified form and might not be to precise scale. In reference to the disclosure herein, for purposes of convenience and clarity only, directional terms, such as, top, bottom, left, right, up, down, over, above, below, beneath, rear, front, distal, and proximal are used with respect to the accompanying drawings. Such directional terms should not be construed to limit the scope of the invention in any manner.

FIG. 1 is a side view of a first embodiment of a beauty and health container according to an aspect of the inventive subject matter.

FIG. 2 is a side view of first embodiment of a beauty and health container with a perspective view of the cap detached from the main body; the lid on the compartment portion is opened.

FIG. 3 is a close-up view of the compartment portion showing a pill inside the compartment.

FIG. 4 is a close-up view of the compartment portion showing a dental floss dispenser in the compartment.

FIG. 5 is a side view of an embodiment showing an original cap detached from an original main body, and a contemplated replacement cap suitable for the original main body.

FIG. 6 is a cross-sectional detailed side view of the first embodiment illustrating the battery and light assembly inside the cap.

FIG. 7 illustrates that a preferred compartment portion is attached to the distal end of the main body.

FIG. 8 illustrates that another embodiment provides a compartment portion attached to the proximal end of the cap.

FIG. 9 is a side view of one embodiment where the compartment portion is a refill, and is detachably attached to the main body by a screw-on spiral blade.

FIG. 10 is a side view of one embodiment where the compartment portion is a refill, and is detachably attached to the main body by click-on lip-and-groove connectors.

FIG. 11 is a side view of another embodiment where the dental floss dispenser is a refill (as shown in perspective view), and is detachably inserted into the compartment.

### DETAILED DESCRIPTION OF THE INVENTION

The invention and its various embodiments can now be better understood by turning to the following detailed description of preferred embodiments, which are presented as illustrated examples of the invention defined in the claims. It is expressly understood that the invention as defined by the claims may be broader than the illustrated embodiments described below.

As used herein, the term “lid” is used interchangeably with the word “cap.” They refer to any type of structure used to keep an opening closed. There is no specific structural requirement for this. For example, a lid can be elongated in shape for an elongated container (such as an eye liner). Or, a lid can be a flat disc, covering a flat disc container (such as a foundation dish). A preferred embodiment in this invention, however, is an elongated lid for an elongated container.

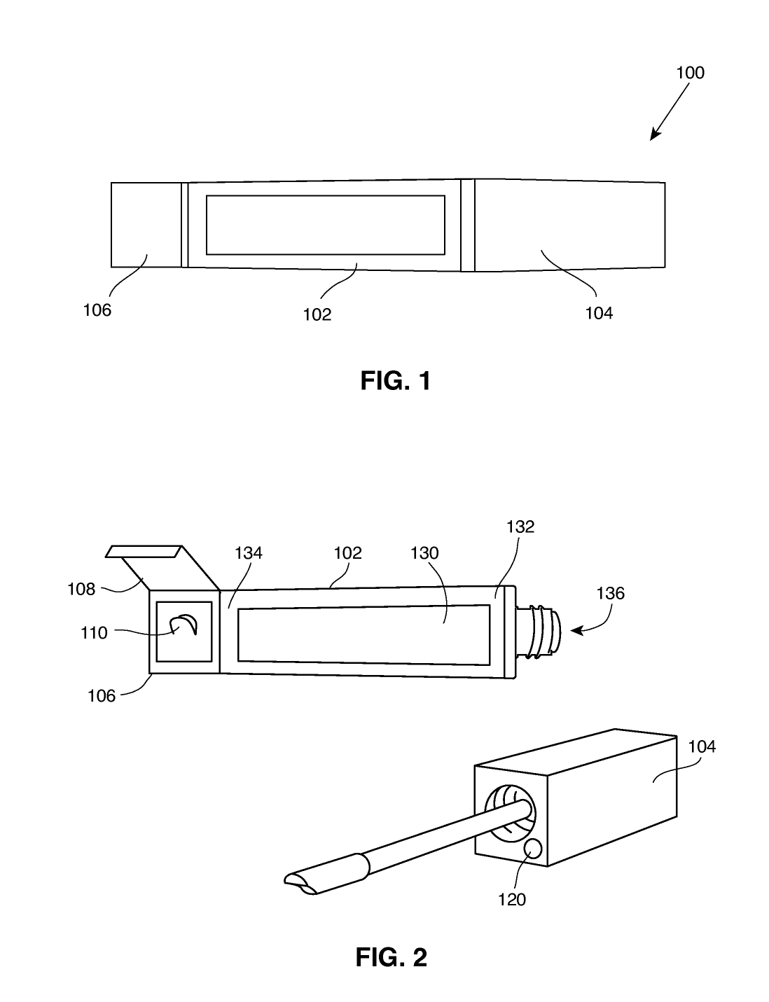

Referring now to FIGS. 1 and 2. In one preferred aspect of the inventive subject matter, a personal-care system 100 has multiple functions. This system 100 has container main body 102, the cap 104, the compartment portion 106 having a compartment 110, and may optionally have a side minor 130, and, optionally, a LED light 120 in the cap 104.

The compartment portion 106 refers to the housing structure that contains an inner space. This inner space is compartment 110.

As shown in FIG. 2, the main body 102 has a distal end 134, a proximal end 132, and a hollow interior space 136 for holding a content. Contemplated contents may be any solid, liquid, paste or powder. The solid, liquid, paste, or powder can be, for example, a beauty or cosmetic product such as lip gloss or a medicament such as pills. The main body 102 can be transparent or non-transparent.

The main body 102 can have any shape. It can be circular, cylindrical, jar-like, or any other shape, and include, for example, any of the containers used in the art for containing cosmetics, whether lipstick, mascara, eyeliner, lip liner, nail polish or so forth. The main body 102 also includes, for example, those used in the art for containing medicaments, such as pills, tablets, capsules, liquids, or powders.

Although this main body 102 may have various shapes, such as a disc-like eye shadow container, a preferred embodiment is an elongated container such as a lip gloss. Other contemplated contents may include, lipstick, mascara, lip liner, nail polish, eye liner, liquid foundation, foundation pressed powder, concealer, blush, eye shadow, skin lotion, and sunblock lotion.

The cap 104 can be, for example, a cap that is capable of being completely detached from the main body 102 (i.e., a removable cap), or a cap that remains attached to the container but moves in a manner capable of opening and closing the fillable container (e.g., a pivoting flip cap).

The cap 104 is coupled to the proximal end 132 of main body to provide a closure to the interior space 136. The cap 104 may be a screw-on cap, a click-on cap, flip-cap, or may be any other known types of cap.

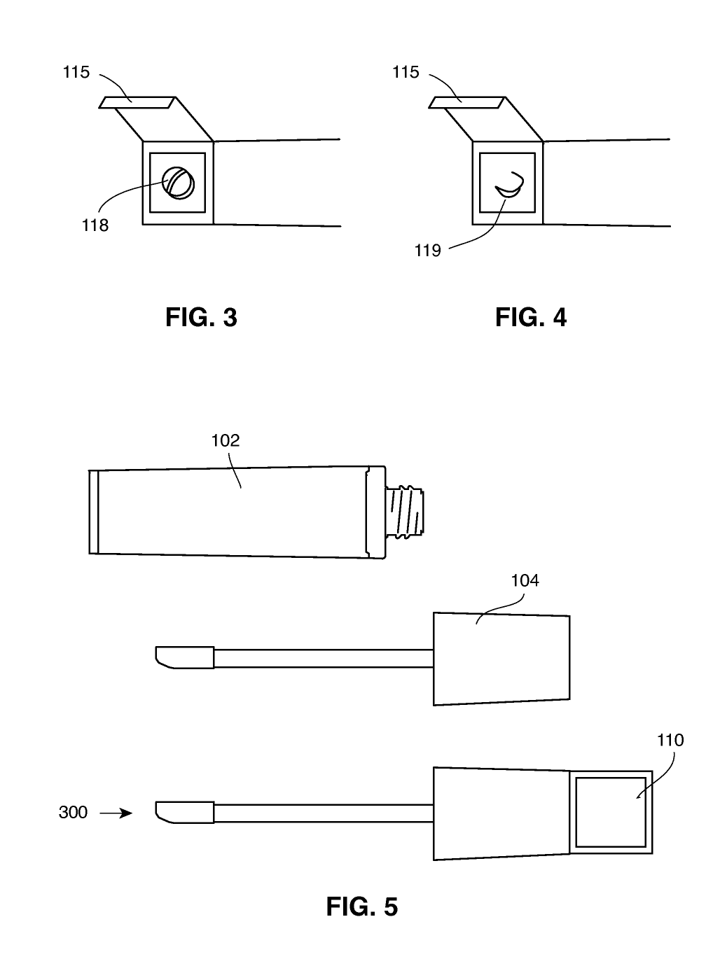

In FIGS. 1 and 2, a compartment 110 is shown coupled to the distal end 134 of the main body. In a preferred embodiment, the compartment 110 is a chamber with an opening to the outside. It should be noted that the main body 102 and the compartment portion 106 is shown in a side view in FIG. 2. Therefore, the opening of the compartment 110 is shown on the same side as the minor 130. Here, the opening is not on the bottom side of the main body 102, perpendicular to the minor 130. Likewise in FIGS. 3 and 4, the compartment 110 opens on the side, which is on the same plane as the minor 130. It is, however, contemplated that the opening to the compartment 110 can be on the bottom side, perpendicular to a plane of the minor 130.

The opening connects the compartment 110 to an outside environment. This compartment 110 is separate from the interior space 136, and the two are not in fluid communication with each other when the cap is closed. This is to be distinguished from typical eye shadow container in a disk-shaped container. Such typical container has multiple compartments within the disk, but all such compartments are in fluid communication with each other when the pivotable lid is closed on the disk.

In yet another preferred embodiment, the compartment portion 106 and the main body 102 are made of one integral piece.

In the embodiment where the compartment portion 106 is in the cap 104, the two may also be made of one integral piece. One skilled in the art would also recognize that the compartment 110 may be separately made so that a compartment portion 106 is physically separable from the main body 102 (or cap 104). In such situations, the compartment portion 106 may be offered as an after-market attachment to various different types and sizes of cosmetic products already in the market. The physically separate compartment portion 106 may be permanently or detachably attached to the main body 102 (or cap 104) by ways commonly known in the art, such as glue, sliding lock, screw-on lock, click-on lock.

A preferred compartment 110 can be left empty for holding personal items such as a pill 118 (see FIG. 3), or it can have a dental floss dispenser 119 disposed within the compartment 110 (see FIG. 4), wherein the dispenser contains a dental floss filament. A preferred dental floss dispenser is one that is commonly-known, having a cutter. The cutter may be made of metal or other suitable material, such as plastic.

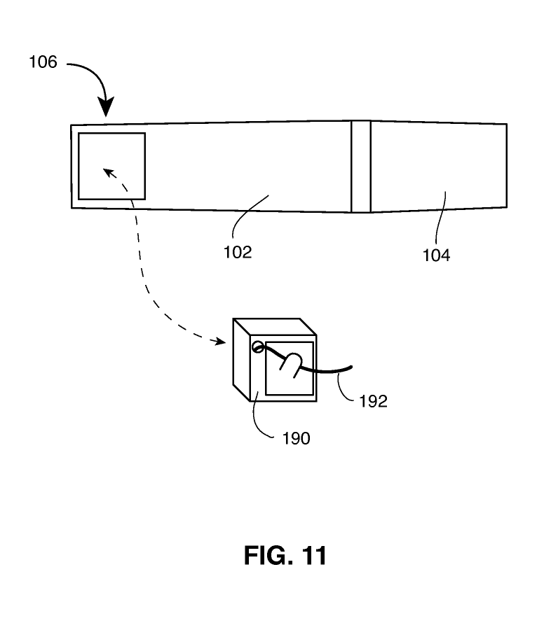

In one preferred embodiment, the dental floss dispenser 119 can be separately sold as a refill and is detachably disposed within the compartment 110 (as illustrated in FIG. 11). The refill can be fitted into the compartment 110 by typical mechanical means known in the art.

As described earlier, the main body 102 can have a mirror disposed on its side wall, so a user may use the mirror when applying the cosmetic content. The minor can also have an elongated shape, and can be attached to the side of the container by adhesives.

An important aspect of one preferred embodiment includes an optional light source disposed on either the main body or the cap. The light source can be any typical light source such as a LED light 120. As shown in FIG. 2, light 120 is disposed in the cap 104 such that the light travels towards the distal end 134 of the main body 102 when the cap 104 is attached to the main body 102. A user may selectively turn on or turn off the light 120. The light 120 provides lighting to brighten area where the cosmetic content is to be applied. When the cap 104 is closed and the light is turned on, the light illuminates the content as well as the main body 102, which can be transparent. This provides an enhanced visual effect in product display/marketing.

While preferred embodiments have the light 120 in the cap, alternatively or additionally the main body 102 can also contain a light. In such cases, the light is preferably located at the bottom of the container body with the light traveling upwards towards the inside content. In other embodiments, the compartment portion 106 can contain a light, such that when it is attached at the distal end of the main body 102, it has a light that shines into the content of the main body 102.

In the contemplated embodiments, the system 100 has an applicator. For example, the applicator may be a brush, for example, for applying a nail polish, lip gloss, foundation, or blush.

FIGS. 2-4 illustrate a preferred embodiment where the compartment 110 also has a lid 115. This optional lid 115 is preferred so that the compartment portion 106 can be covered and has an outside appearance to look like a natural extension of the cosmetic container/applicator.

It is important to appreciate that although the present invention is particularly well suited to have the compartment 110 located at the distal end 134 of the main body 102, another embodiment may provide such compartment 110 at the cap 104.

For example, in FIG. 5, a common lip gloss container has a main body 102 and a cap 104. This common lip gloss container does not have a compartment portion on its distal end. An after-market replacement lid 300 is provided to replace cap 104. Replacement lid 300 has a compartment 110 disposed at an end of the lid body as shown. Such replacement lid 300 provides added value to the original lip gloss applicator. A user may now dispose of the original cap, and use the replacement cap 300 with the original container. Compartment 110 is shown here to open on the side of the cap. It is also contemplated that it can open on the top side wherein the top side is perpendicular to a longitudinal axis of the applicator rod.

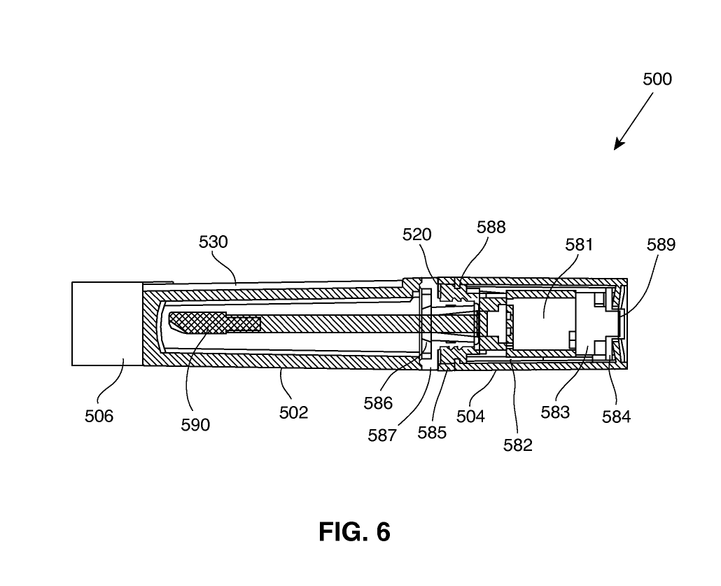

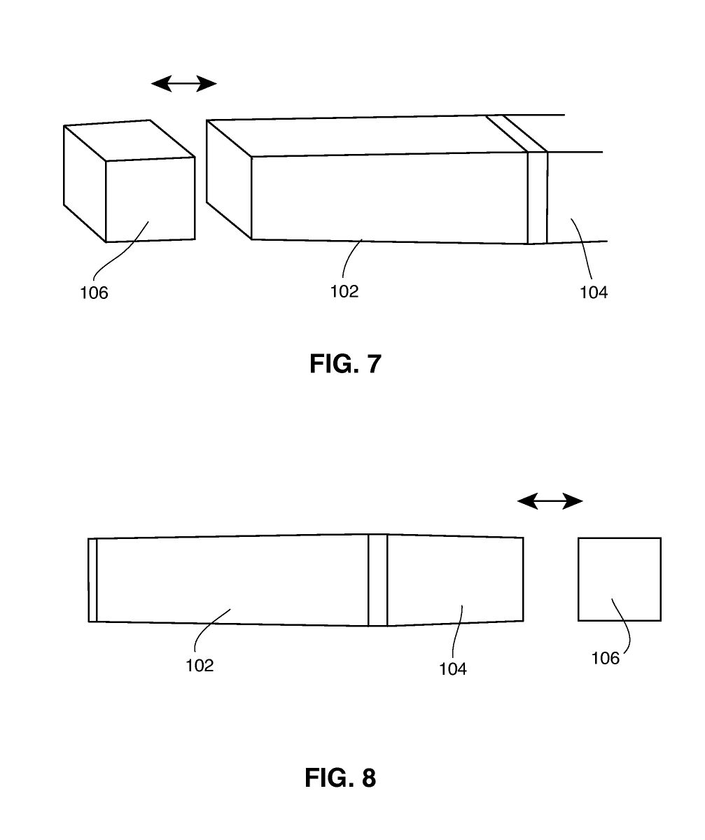

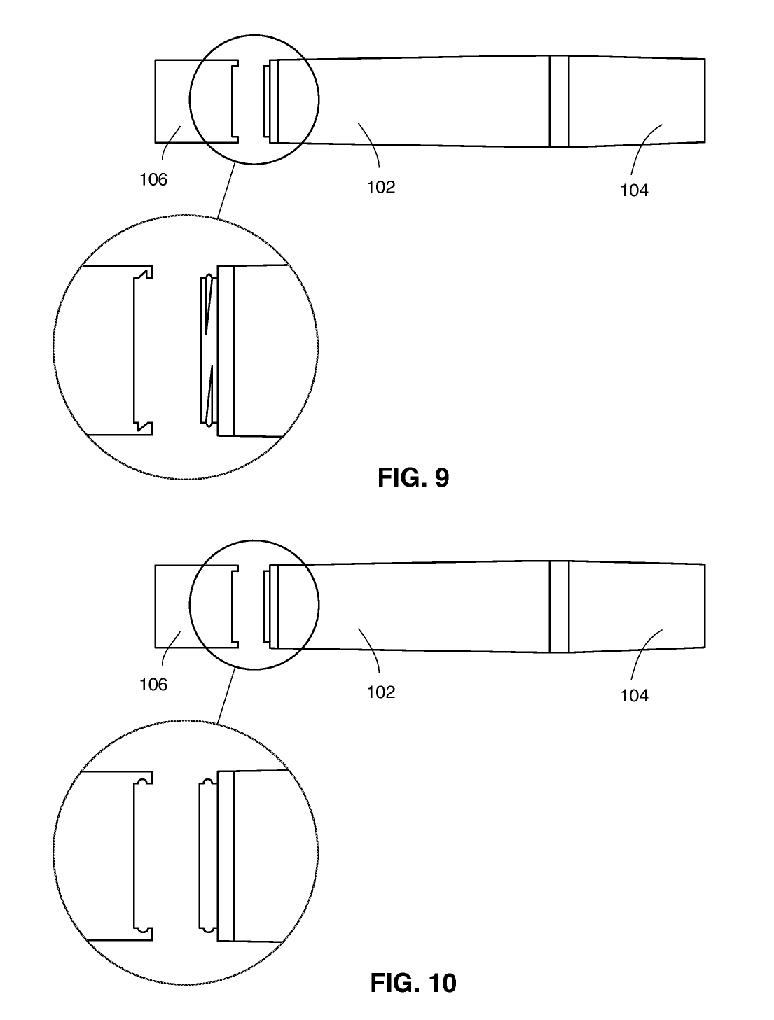

FIG. 6 illustrates a cross-sectional side view of one contemplated embodiment 500, showing especially the battery/light assembly. In FIG. 6, the battery/light assembly is located in the cap 504. Similar to the previously described cap 104, cap 504 is generally elongated in shape, has a collar 585 around the rim of the cap 504, and has battery housing 582 to hold batteries 581 to supply power to the light 520. The detailed wiring and mechanical arrangement of the battery, conducting wires, LED bulb, contact spring, contact cap, are known in the art. One skilled in the art would immediately understand the arrangement of such battery/light assembly as it is commonly seen, such as pens with LED lights.

As is typical in a nail polish or lip gloss container, the cap 504 has an elongated rod with an applicator, for example a brush or a doe foot applicator 590 at its distal end for applying nail polish, lip gloss, etc. The main body 502 of the container has a wiper 586 enclosing and encircling the opening of the main body 502. The wiper 586 provides an opening of sufficient diameter such that the doe foot applicator 590 may exit. A user may use the wiper 586 to wipe away excess nail polish.

Light 520 is located near the rim of the cap, and faces towards the main body 502 so that the intended direction where the light travels is towards the doe foot applicator 590.

When a user is using the doe foot applicator to apply, for example, nail polish to a nail, the light 520 is able to shine light onto the nail. This is particularly helpful when applying cosmetic product in a dimly-lit or dark environment. When the cap 504 is attached to the main body 502, a user may also selectively turn on the light by depressing button 589 of switch 583. When the light is turned on with the cap 504 screwed on tight to the main body 502, light travels from LED bulb 520 through the transparent wall of the main body 502. The main body 502 and its content are lit up, offering a pleasing visual effect. As discussed earlier, main body 502 has mirror 530 disposed along its side. Compartment portion 506 is disposed at the distal end of the main body 502.

FIGS. 9 and 10 illustrate ways a compartment portion 106 can be detachably attached to the main body 102. In these two examples, the compartment portion 106 is a refill, and can be replaced by another such refill when the dental floss is used up. In FIG. 9, the compartment portion 106 is connected to the main body by screw-on spiral blades. In FIG. 10, the compartment portion 106 is connected to the main body 102 by click-on lip-and-groove structures.

In FIG. 11, a dental floss dispenser refill is shown having a housing 190 to enclose a dental floss filament 192. a distal end of the filament 192 extends through the aperture in the housing wall such that the distal end is exposed outside of the housing 190. As shown, the distal end of the filament 192 is held by the protruding cutter 194 of a plate 193. The plate 193 may be made of metal or other suitable material, such as plastic. The construction of such protruding cutter 194 and plate 193 are known in the art.

Many alterations and modifications may be made by those having ordinary skill in the art without departing from the spirit and scope of the invention. Therefore, it must be understood that the illustrated embodiments have been set forth only for the purposes of example and should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Thus, specific embodiments and applications of beauty and health containers have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A personal-care system having multiple functions, said system comprising:
a main body having a distal end, a proximal end, and a hollow interior space;
a first lid coupled to said proximal end of said main body;
an amount of cosmetic content disposed within said hollow interior space;
a compartment coupled to either said distal end of said main body or said first lid;
an opening connecting said compartment to an outside environment, and
wherein said compartment is not in fluid communication with said hollow interior space when said first lid and said main body are coupled together.

2. The personal-care system as recited in claim 1 further comprising a compartment portion, wherein said compartment is disposed in said compartment portion, wherein said compartment portion and either said first lid or said main body are made of one integral piece.

3. The personal-care system of claim 1 further comprising a compartment portion, wherein said compartment is disposed in said compartment portion, wherein said compartment portion is detachably coupled to either said first lid or said main body.

4. The personal-care system of claim 2, further comprising a dental floss dispenser disposed within said compartment, wherein said dispenser contains a dental floss filament.

5. The personal-care system of claim 3, further comprising a dental floss dispenser disposed within said compartment, wherein said dispenser contains a dental floss filament.

6. The personal-care system as recited in claim 4 wherein said dental floss dispenser is detachably disposed within said compartment, and can be replaced by another said dental floss dispenser.

7. The personal-care system as recited in claim 5 wherein said dental floss dispenser is detachably disposed within said compartment, and can be replaced by another said dental floss dispenser.

8. The personal-care system of any one of claims 7, further comprising a mirror disposed on said main body.

9. The personal-care system as recited any one of claims 8, wherein said content is a member selected from a group consisting of a lip gloss, a lipstick, a mascara, a liquid foundation, a foundation pressed powder, a concealer, a blush, an eye shadow, a skin lotion, a sunblock lotion, a lip liner, a nail polish, and an eye liner.

10. The personal-care system as recited in claim 9, wherein said content is a member selected from a group consisting of a mascara, a lip gloss, and an eye liner; and wherein a light source is disposed on either the main body or the lid.

11. A device to add functionality to a cosmetic container, said device comprising:
a compartment portion having a compartment and an opening connecting said compartment to an outside environment;
wherein said cosmetic container has a main body, and an original lid coupled to said main body;
wherein said compartment portion has attachment means for attaching to one of said original lid or said main body.

12. The device of claim 11 further comprising a dental floss filament disposed within said compartment.

13. The device of claim 11, wherein said attachment means is to detachably attach said device to one of said original lid or said main body.

14. The device of claim 12, wherein said attachment means is to detachably attach said device to one of said original lid or said main body.

15. The device of any one of claims 13-14 further comprising a lid portion integral with said compartment portion such that the device is a replacement lid to replace said original lid for coupling with said main body.

16. The device of claims 15, further comprising a dental floss dispenser re-fill to contain said dental floss filament.

17. A dental floss dispenser refill, wherein said refill comprises:
a dental floss filament disposed within a housing;
said dental floss dispenser is sized to fit into a compartment of a cosmetic container;
wherein the cosmetic container has a main body and a lid coupled to said main body;
and wherein either said main body or said lid has said compartment and an opening communicating said compartment with an outside environment.

18. The refill of claim 17, wherein said cosmetic container has a content in said main body, and said content is a member selected from a group consisting of a lip gloss, a lipstick, a mascara, a liquid foundation, a foundation pressed powder, a concealer, a blush, an eye shadow, a skin lotion, a sunblock lotion, and an eye liner.

19. A method of adding functionality to a cosmetic container, the method comprising:
providing a compartment portion having a compartment;
wherein the compartment portion is coupled to a main body or to an original lid of the cosmetic container; and,
wherein said compartment has at least one of the following functions:
a. sized to contain a pill;
b. dispensing a dental floss filament.

20. The method of claim 19, further comprising the step of providing a dental floss dispenser refill sized to fit within said compartment.

21. The method of claim 19, wherein said compartment portion is an after-market product and has attachment means to couple to said main body or said original lid of the cosmetic container.

22. The method of claim 21, wherein said compartment portion is a replacement lid, said method further comprising the step of providing said replacement lid to a consumer to replace said original lid.

23. The method of claim 19, wherein said compartment portion is an integral part to said main body or to said original lid of the cosmetic container.

24. The method of claim 19, further comprising the step of providing a minor disposed on the main body of the cosmetic container.
